(19) United States
(12) Patent Application Publication
(10) Pub. No.: US 2012/0012424 A1
(43) Pub. Date: Jan. 19, 2012

(54) Universal Fan Support Bracket and Fan Assemblies for Elevated Work Platforms

(76) Inventor: Anthony Walker Bowman, Stafford, VA (US)

(21) Appl. No.: 12/835,686

(22) Filed: Jul. 13, 2010

(51) Int. Cl. E06C 7/14; E06C 7/00; F04D 29/40

(52) U.S. Cl. 182/129; 415/126; 248/210

(57) ABSTRACT

An adjustable fan support frame for positioning an electric fan on a step ladder, scissor lift or other elevated working platform. The fan support frame may be configured for four-point attachments to be ladder or other elevated working platform. The fan may be attached to the frame by a pair of attachment arms with pivot joints, which may include an adjustable friction member to permit the fan to be rotated about the attachment arms and then fixed in a given orientation. The pivot arms may be similarly attached to the frame with pivot joints which may also be configured with friction members for controllable positioning of the arms with respect to the support frame. The frame may be supported by diagonal brace members coupled to the frame by a pivot joint and attached to the ladder or other elevated working platform via an attachment surface.

### BACKGROUND

Many construction jobs require workers to work from an elevated position, such as by standing on a step ladder or working on a scissor lift or other elevated work platform. During times of hot weather, working in such an elevated position can be difficult due to the higher temperatures just a few feet above the ground. Additionally, positioning fans on the floor directed towards workers in an elevated position can be inefficient due to the distance between the fan and the worker in such situations.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a perspective view of a conventional ladder suitable for use with the various embodiments.

FIG. 2 is a perspective view of a fan and support frame assembly according to an embodiment.

FIG. 3 is a perspective view of the fan in support frame assembly shown in FIG. 2 coupled to the ladder shown in FIG. 1 in a first position.

FIG. 4 is a perspective view of the fan in support frame assembly shown in FIG. 2 coupled to the ladder shown in FIG. 1 in a second position.

FIG. 5A and 5B are side views of another embodiment of the fan support frame assembly.

FIGS. 6A-6C are top and side views of an embodiment of a frame attachment bracket.

FIGS. 7A and 7B are side views of two embodiments of the fan support frame assembly configured for attachment to a scissor lift.

FIGS. 8A and 8B are side and end views of an embodiment fan attachment bracket configured to rotate about a swivel.

FIGS. 9A and 9B are a side and detail view of an embodiment fan attachment bracket configured to rotate about a swivel and expand or contact to fit fans of various sizes.

FIG. 10 is a side view of another embodiment configured to expand or contact to fit fans of various sizes.

FIG. 11 is a detailed view of an embodiment bracket for coupling the fan support frame to a ladder.

FIGS. 12A through 12C are top and side views of an embodiment fan support frame configured with a hinge to enable the fan to be rotated down after the fan support frame has been attached to a ladder or other elevated work platform.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The various embodiments provide an adjustable mounting frame for positioning an electric fan on a step ladder, scissor lift or other elevated working platform. The electric fan may be battery powered for safety. The fan support frame may be configured for convenient four-point attachments to a ladder or other elevated working platform. The electric fan may be attached to the fan support frame by a pair of attachment arms with pivot joints, which may include an adjustable friction member to permit the fan to be rotated about the attachment arms and then fixed in a given orientation. The pivot arms may be similarly attached to the fan support frame with pivot joints which may also be configured with friction members for controllable positioning of the fan. The fan support frame may be supported by diagonal brace members that may be coupled to the fan support frame by a pivot joint and attached to the ladder or other elevated working platform via an attachment surface. The fan support frame may be attached to the ladder or other elevated working platform with a bracket, such as an L bracket. In an embodiment, the frame attachment bracket may be configured to fit within interior contours of a channel structure of a ladder or other elevated working platform. The frame attachment bracket may be coupled to the ladder or other elevated working platform with bolts or removable clamps, such as a C-clamp, or removable brackets. Similarly, the diagonal brace member mounting surface may be coupled to the ladder or other elevated working platform by bolts attached to the structure by removable clamps, such as a C-clamp, or removable brackets. In an embodiment, the fan attachment frame may be configured to telescope in order to move the fan closer or farther from the ladder or elevated work platform, and/or expand or contract to accommodate different size electric fans.

The various embodiments provide a portable and easy-to-position fan mounting structure can be configured to position an electric fan in the vicinity of a worker using the ladder or other elevated working platform. By placing the fan closer to the worker, the various embodiments provide better cooling, while enabling the use of smaller, more energy-efficient fans. By positioning the fan close to the worker, battery operated fans may be used, thereby eliminating trip and electrocution hazards posed by electrical extension cords. By attaching the fan rigidly to the ladder or other elevated working platform, the various embodiments provide a rigid and strong support structure that enables the ladder to be repositioned with the fan in place

In an embodiment, the fan may be configured with rechargeable batteries to provide a rechargeable fan and a support structure assembly. By attaching the fan support structure to the ladder or other lift structure using removable attachment clamps or brackets, a rechargeable fan and frame assembly 10 can be disconnected from the ladder for charging and easily replaced by a fully charged unit. In a preferred embodiment, the electric fan may be configured to use the standard rechargeable batteries used in common power tools, which is typically a lithium hydride battery with a standard shape and electrical connector configuration. Using a standard replaceable rechargeable battery would enable the electric fan to be equipped with fresh batteries without removing the fan assembly from the ladder 1.

A rechargeable fan assembly may include an electric fan and a rechargeable battery coupled to the fan via a control switch. The rechargeable battery may be any known type of rechargeable battery, such as a nickel-cadmium or a lithium-hydride battery, and as mentioned above, may be a standard power tool rechargeable battery. Additionally, the rechargeable fan may include a battery charging module including a charge controller and converter for transforming AC electrical current into appropriate DC current with the appropriate voltage, along with a charge monitoring and control unit configured to manage the recharging of the fan battery. Additionally, the fan may include a power connection or power cord for coupling the battery charging module to standard electrical outlets.

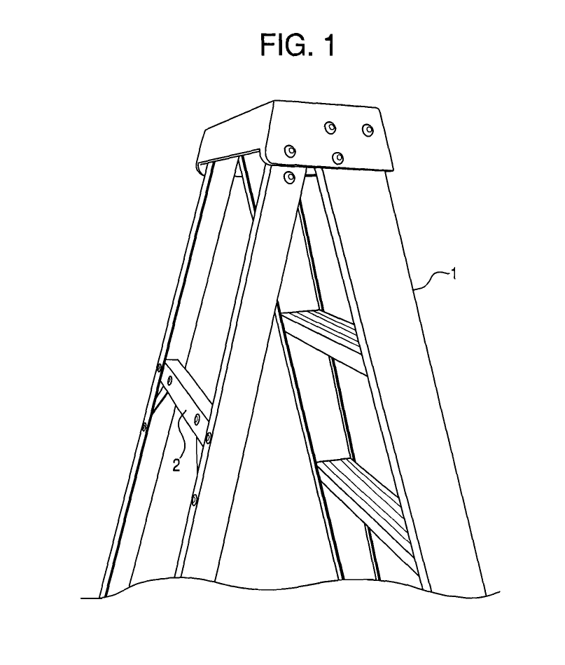

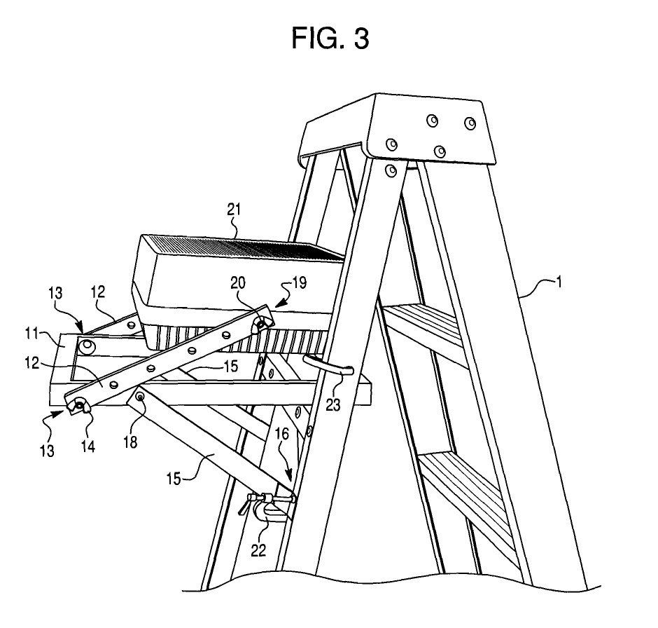

The various embodiments may be used on any of a variety of ladders and other elevated working platforms. For example, the various embodiments may be implemented on a conventional step ladder as shown in FIG. 1. A typical stepladder 1 includes horizontal brace members 2 which may be used for positioning the fan support frame as described below with reference to FIG. 3.

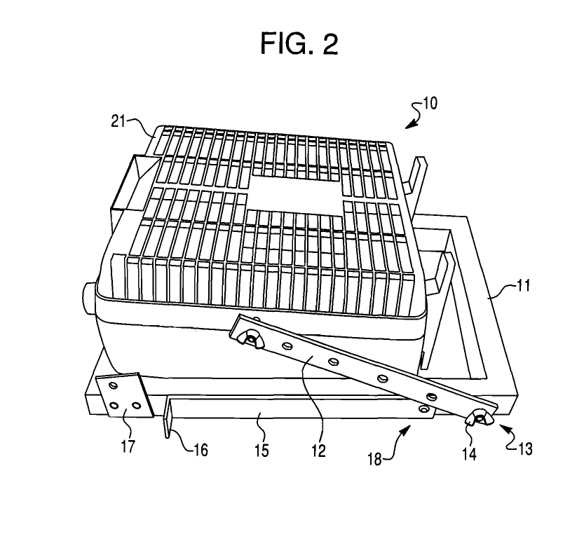

An example embodiment of a fan and support frame assembly 10 is illustrated in FIG. 2. In this embodiment, the fan and support frame assembly 10 includes a fan support frame 11 to which is attached two fan attachment arms 12 by a pivot joint 13, such as a bolt with washers and a wingnut 14. Such a pivot joint 13 allows the fan attachment arms 12 to pivot about the joint so as to position the fan 21 in different locations with respect to the support frame 11. A friction adjustment device, such as a wingnut, bolt and washer assembly 14 enables a user to quickly reduce the friction in the pivot joint in order to reposition the fan attachment arms 12 to a suitable angle, and then tighten the wingnut 14 in order to hold the fan 21 in a desired configuration.

A diagonal support brace 15 may be coupled to either side of the support frame 11 by pivot joints 18. An attachment surface 16, such as an L bracket, may be connected to the diagonal support brace 15 for coupling to the ladder structure as described below with reference to FIG. 3.

A frame attachment bracket 17 may be coupled to the support frame 11 and configured for easy attachment to the ladder or other lift structure. In an embodiment, the frame attachment bracket 17 is in the form of an L bracket. In another embodiment, the frame attachment bracket 17 is configured in terms of its angle and width to fit within contours of the channel structural members of the ladder, as described below with reference to FIG. 3.

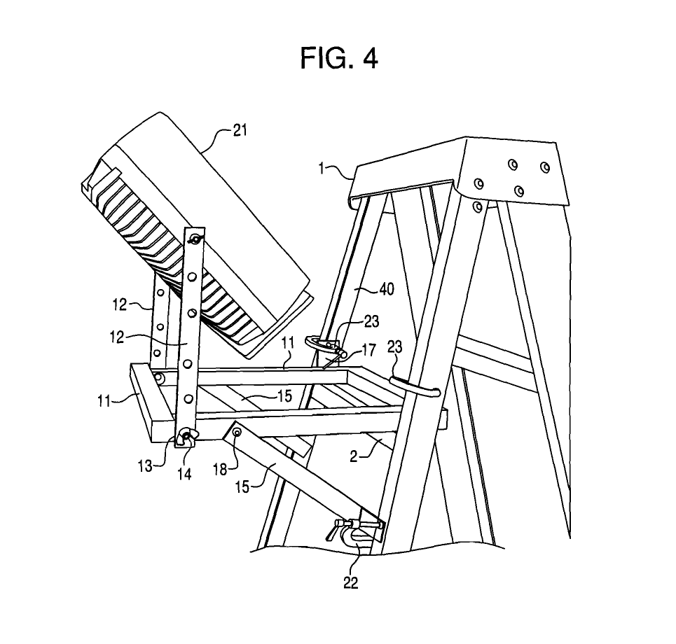

The electric fan 21 may be coupled to the fan attachment arms 12 by a pivot joint 19, which may include a friction adjustment mechanism, such as a wingnut, bolt and washer assembly 20. Attaching the fan 21 to the fan attachment arms 12 with such a pivot joint 19 enables the fan to be redirected in order to point it in a desired direction, as described below with reference to FIG. 4.

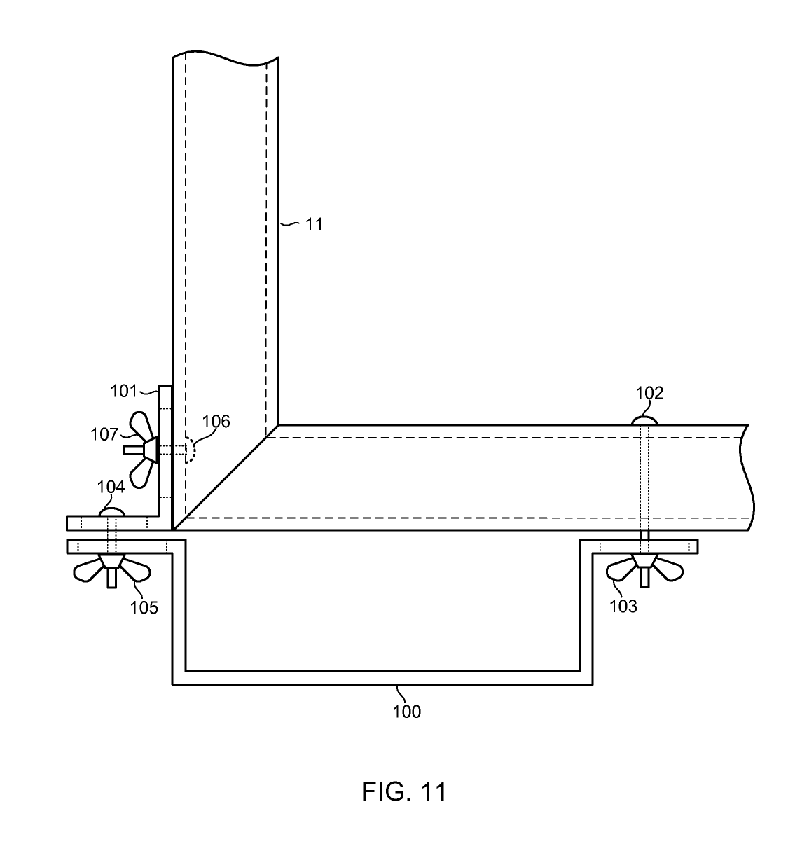

FIG. 3 illustrates the embodiment described above with reference to FIG. 2 when installed on a step ladder 1. As FIG. 3 illustrates, the frame attachment bracket 17, the pivoting attachment diagonal support brace 15, and the attachment surface 16 enable the fan and support frame assembly 10 to be easily attached to a ladder 1. For example, the attachment bracket 17 may be positioned within the channel structure of the ladder 1 and then removably held in place with a removable bracket 23, such as a C-clamp. Similarly, the diagonal support brace attachment surface 16 may be coupled to the ladder 1 using a removable clamp, such as a C-clamp. Alternatively, the attachment bracket 17 and brace attachment surface 16 may be bolted or riveted to the ladder structure. Other forms of removable attachment brackets may be used, including Velcro straps, vice grips, etc. Another embodiment using a bolt and bracket assembly is described below with reference to FIG. 11.

FIG. 3 illustrates how the support frame 11 may rest upon a horizontal brace member 2 of the ladder to provide a vertical support to the frame 11, while the diagonal support brace 15 prevents rotational movement of the frame 11 about the horizontal brace member 2. A variety of different ladder sizes and configurations may be accommodated by adjusting the angle of the diagonal support brace 15 by pivoting it about its pivot joint 18.

FIG. 4 illustrates the fan 21 positioned in a configuration that may be suitable for use by a worker standing on a ladder 1. In this configuration the fan support brackets 12 have been pivoted about the pivot joint 13 and the fan 21 has been pivoted about the pivot joints 19 in order to point the direction of the fan towards a worker standing on the step ladder 1. As FIG. 4 illustrates, the pivot joints 13 and 19 on the fan support brackets 12 enabled the fan to be positioned in a wide range of positions and orientations in order to best direct the airflow towards the worker or in another desired direction.

The support frame 11 may be made out of a variety of materials, such as metals, plastics, wood and other structural material. The support frame 11 may be made out of round or square tubing, channel beams, L beams, I beams, or other types of structural members with structural strength and rigidity. The fan support bracket 12 and diagonal support brace 15 may be made from a variety of structural materials, such as metals, plastic, wood, etc., and may be flat bars, L beams, round or square tubing, channel beams, I beams, or other configurations which provide structural strength with a configuration that resists buckling.

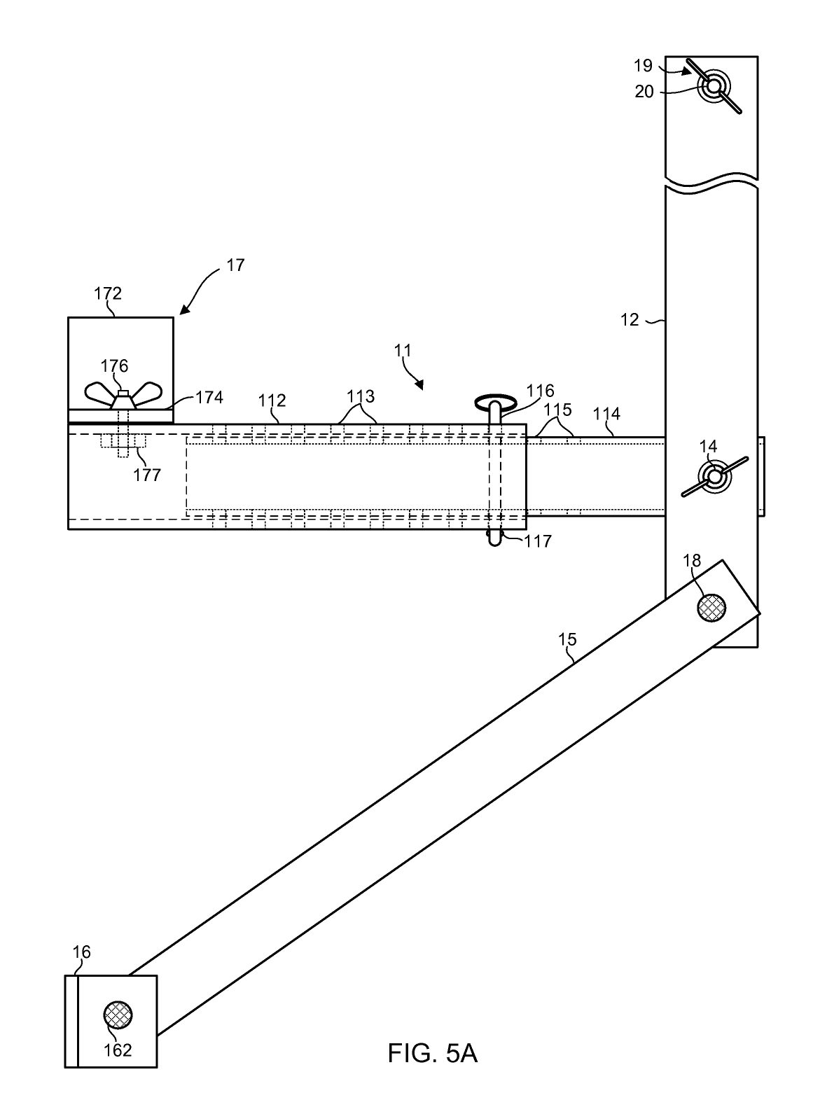

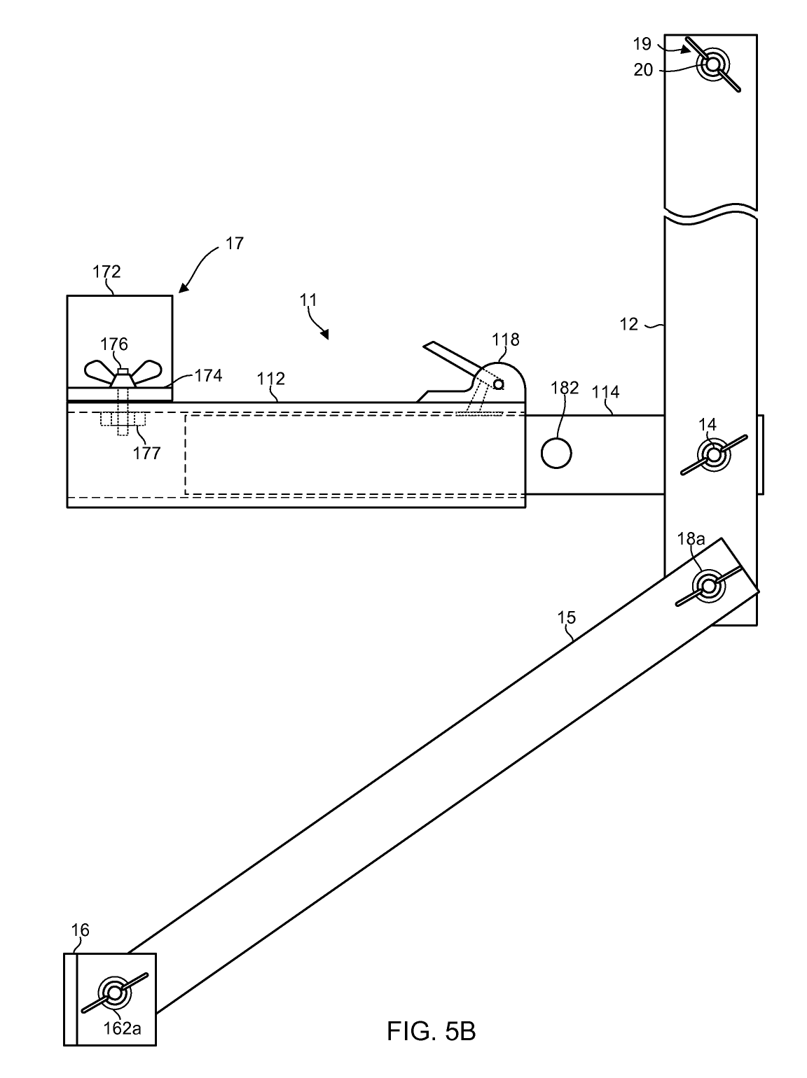

In another embodiment illustrated in FIG. 5A, the fan support frame 11 may be configured with telescoping portions so that the distance from the fan to the ladder or other elevated work platform can be adjusted. In an example embodiment, the legs of the fan support frame 11 that extend from the ladder may be configured as two tubes 112, 114 sized so that one tube 114 fits within the other tube 112. In the illustrated embodiment, the inner and outer tubes 114, 112 may be configured with through holes 113, 115 through which a locking pin 116 may be threaded in order to fix the position of the fan with respect to the ladder. Such a locking pin 116 may be configured with spring-loaded detents 117, a hole for positioning a cotter pan (not shown), or other mechanism for ensuring that the locking pin 116 does not fall out. In this embodiment, the distance of the fan from the ladder can be adjusted simply by pulling out the locking pin 116, sliding the outer portion of the frame away from the ladder, which draws the inner tube 114 out from the outer tube 112, until the desired position is achieved, lining up the holes 113 in the outer tube 112 with the holes 115 in the inner tube 114, and then reinserting the locking pin 116.

Providing telescoping arms for the fan support frame 11 enables a worker to quickly collapse the fan support frame 11 to minimize the width of the ladder with the fan installed to a dimension that will enable the ladder and fan to fit between studs of a wall before drywall is installed. Many jobs requiring the use of a step ladder involve working in ceilings and upper portions of walls lay wiring, air-conditioning ducts, and other utilities before drywall is installed. The ability to collapse the width of the fan support frame 11 enables workers to pass the ladder and fan assembly through the studs of walls, thereby improving their mobility on the job site.

FIG. 5A also illustrates an alternative configuration for coupling the diagonal support brace 15 to the fan support frame 11. In this embodiment, the diagonal support brace 15 is coupled to the fan attachment arms 12 by a pivot joint 18. This configuration may enable the fan support frame 11 to be collapsed to a greater extent than if the diagonal support brace 15 were coupled directly to the frame as shown in FIGS. 2-4. This embodiment may also enable the diagonal support brace 15 to help hold the fan attachment arms 12 in a vertical orientation. In this embodiment, the pivot joint 18 attaching the diagonal support brace 15 to the fan attachment arms 12 may be a bolt, a loose fitting rivet, or any other type of fastener which permits the diagonal support brace 15 to rotate with respect to the fan attachment arms 12.

FIG. 5A also illustrates how the diagonal support brace attachment surface 16 can be coupled to the diagonal support brace 15 by a pivot joint 162. In this embodiment, the attachment surface 16 may be in the form of an L bracket that can be rotated about the pivot joint 162 to position the attachment surface in an appropriate orientation to couple to the ladder or other elevated work platform.

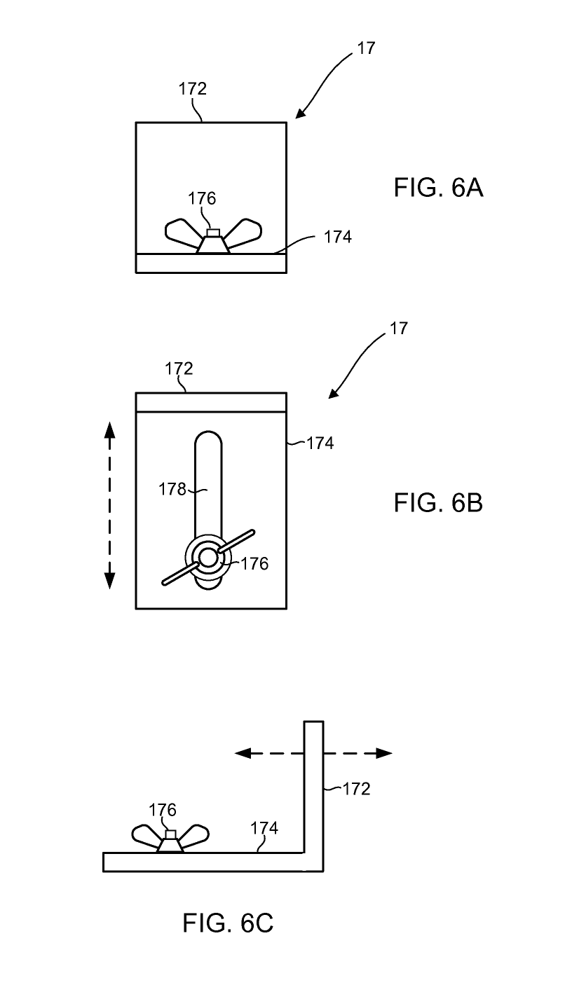

FIG. 5A also illustrates details regarding an embodiment for the frame attachment bracket 17. In this embodiment, the frame attachment bracket 17 is in the form of an L bracket having a vertical surface 172 and a horizontal surface 174. In order to enable the frame attachment bracket 17 to move towards or away from the centerline of the fan support frame 11, the bracket 17 may be configured with a slot into which an adjustable fastener, such as a wingnut and bolt assembly 176, 177, is positioned so that the bracket can be held in one position. By loosening the wingnut, the frame attachment bracket 17 can be moved to fit inside a structure of the ladder. Once in place, the wingnut 176 can be tightened in order to hold the frame attachment bracket 17 in place. Details of this embodiment of the frame attachment bracket 17 are described below with reference to FIGS. 6A-6C.

Another embodiment that enables the distance between a ladder and the fan to be adjusted is illustrated in FIG. 5B. In this embodiment, the legs of the fan support frame 11 that extend from the ladder may be configured as two tubes 112, 114 sized so that one tube 114 fits within the other tube 112. Instead of using locking pins to hold the legs of the frame in place, a locking mechanism 118 is provided on the exterior pipe 112. Such a locking mechanism may be similar to those commonly used in beach umbrellas, tents, and other telescoping structural assemblies. For example, the locking mechanism 118 may depress a pad against the inner tube 114 to hold the tubes in position by a friction. In another example, the locking mechanism 118 may constrict the diameter of the outer tube 112 to press against and create a high fraction interface with the inner tube 114.

FIG. 5B also illustrates an alternative embodiment in which a hole 182 may be provided in the fan support frame 11, such as in the inner tube 114, to enable the diagonal support brace 15 to be connected to the frame instead of a fan attachment arms 12 as shown. This embodiment enables the support brace 15 to be connected to either the frame 11 or the fan attachment arms 12 in order to fit the particular geometry of the elevated work platform to which the fan assembly is attached.

As discussed above, in an embodiment the frame attachment bracket 17 is in the form of an L bracket as illustrated in FIG. 6A-6C. FIG. 6A shows the side profile of the frame attachment bracket 17 as illustrated in FIG. 5A. FIG. 6B shows a top profile view of the frame attachment bracket 17. This view shows the slot 178 in which is positioned an adjustable fastener (e.g., a bolt and wingnut assembly 176) which can be used to lock the bracket into a position. FIG. 6C shows a side profile view of the frame attachment bracket 17. As illustrated in FIGS. 6B and 6C, when the wingnut 176 is loosened, the bracket 17 can be moved along the axis of the slot 178 as shown by the dashed arrows. This embodiment allows the vertical portion of the bracket to be retracted inward towards the centerline of the fan support frame 11 to fit between the legs of the ladder 1 and then slid outward away from the centerline of the frame to fit into the channels of the ladder legs, and secured in place (e.g., with a wingnut and bolt assembly 176) to secure the frame to the ladder.

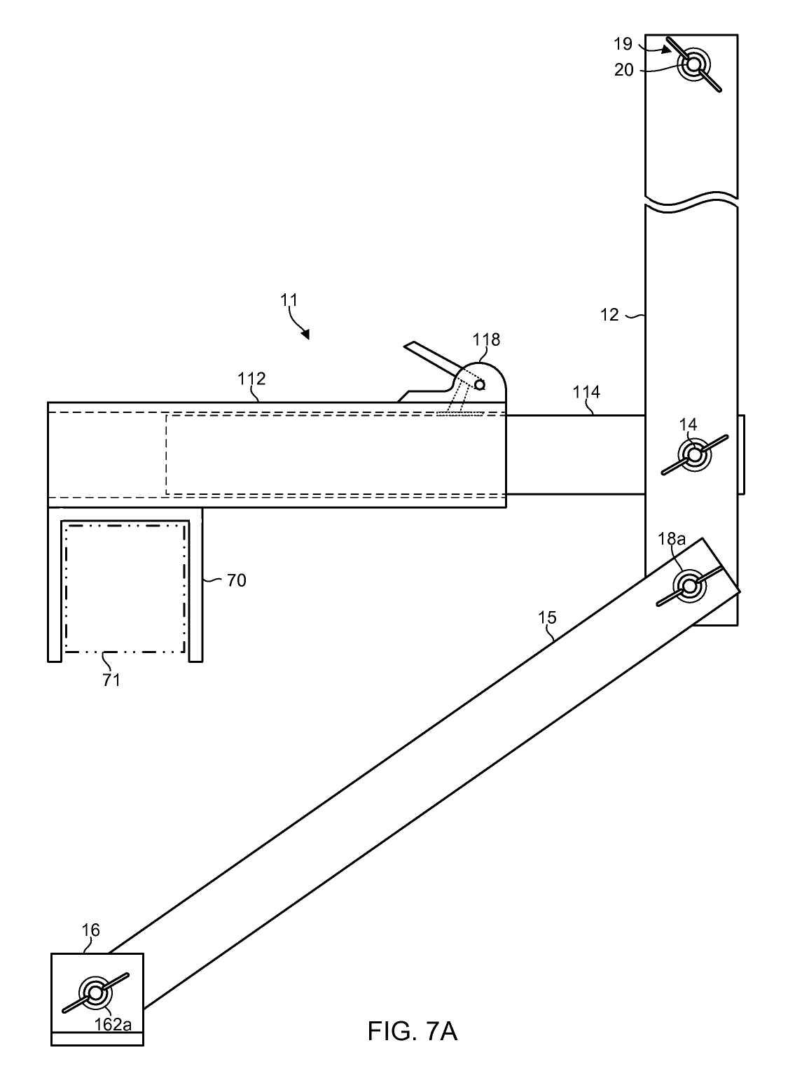

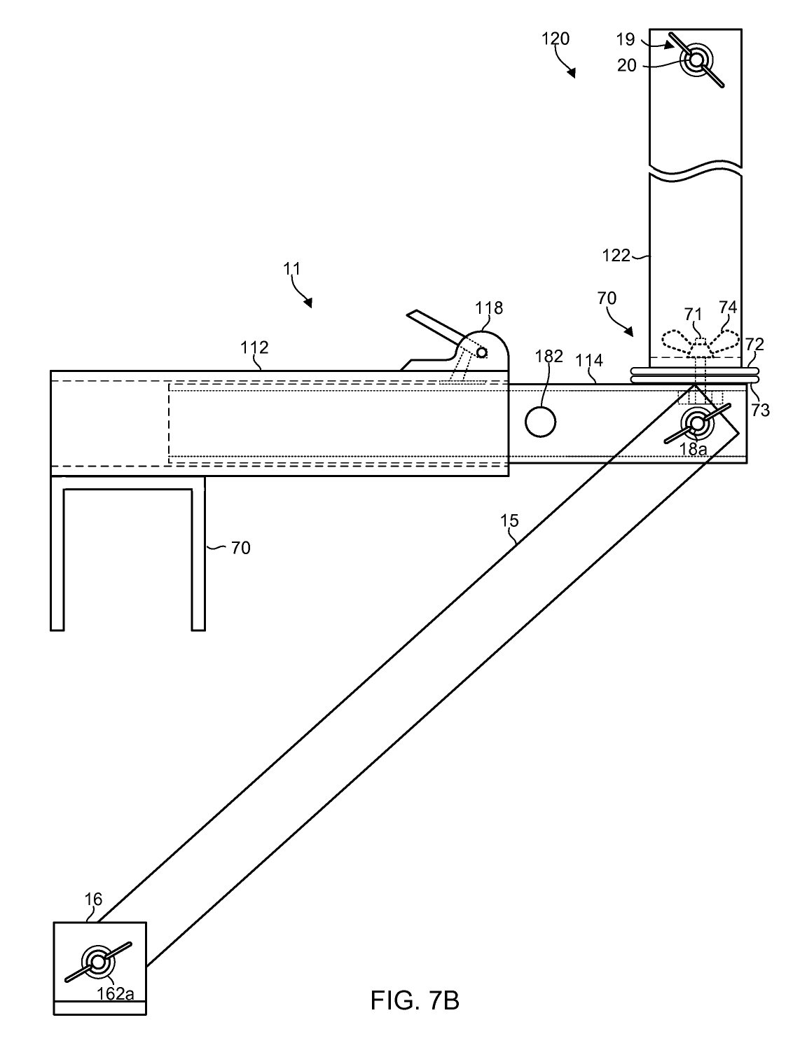

In a further embodiment illustrated in FIG. 7A, the attachment bracket for coupling the fan support frame 11 to an elevated platform may include a square channel bracket 70 for coupling the frame to a side rail 71 of a scissor lift. In this manner, an electric fan can be positioned within the workspace of a scissor lift by slipping the square bracket 70 over the middle or top rail 71 of a scissor lift and positioning the diagonal support brace attachment surface 16 against a side or the standing surface of the lift.

FIG. 7A also illustrates how the diagonal support brace interface surface 16 may be rotated in order to match a surface of the elevated work platform. For example, in FIG.7A, the attachment surface 16 is turned 90° about a rotatable connection 162 so that it may be coupled to the standing surface of a scissor lift. As illustrated in FIG. 7A, the rotatable connection between the attachment surface 16 and the diagonal support brace 15 may be adjustable, such as with a wingnut 162a, in order to hold the attachment surface 16 in a particular configuration. Other components shown in FIG. 7A are substantially the same as like number parts described above with reference to FIG. 5B.

In a further embodiment illustrated in FIG. 7B, the fan attachment arms 120 may be configured to rotate about a swivel 70 mounted on the fan support frame 11. Any of a variety of swivels may be use to enable the fan attachment arms 120 to swivel about a point on the fans support frame 11. As a simple example embodiment, a swivel 70 may include an axel 71 coupled to the fan support frame 11, such as by a bolt, with one, two or more washers 72, 73 positioned between the frame and the fan attachment arms 120 and configured to enable the fan attachment arms 120 to swivel smoothly about the axle 71. For example, the washers 72, 73 may be coated with a low friction material, such as Teflon®, on the contact surfaces. A tension adjusting mechanism, such as a wingnut 74, coupled to the axel 71 may be provided to enable the fan attachment arms 120 to be fixed at a particular angle of rotation.

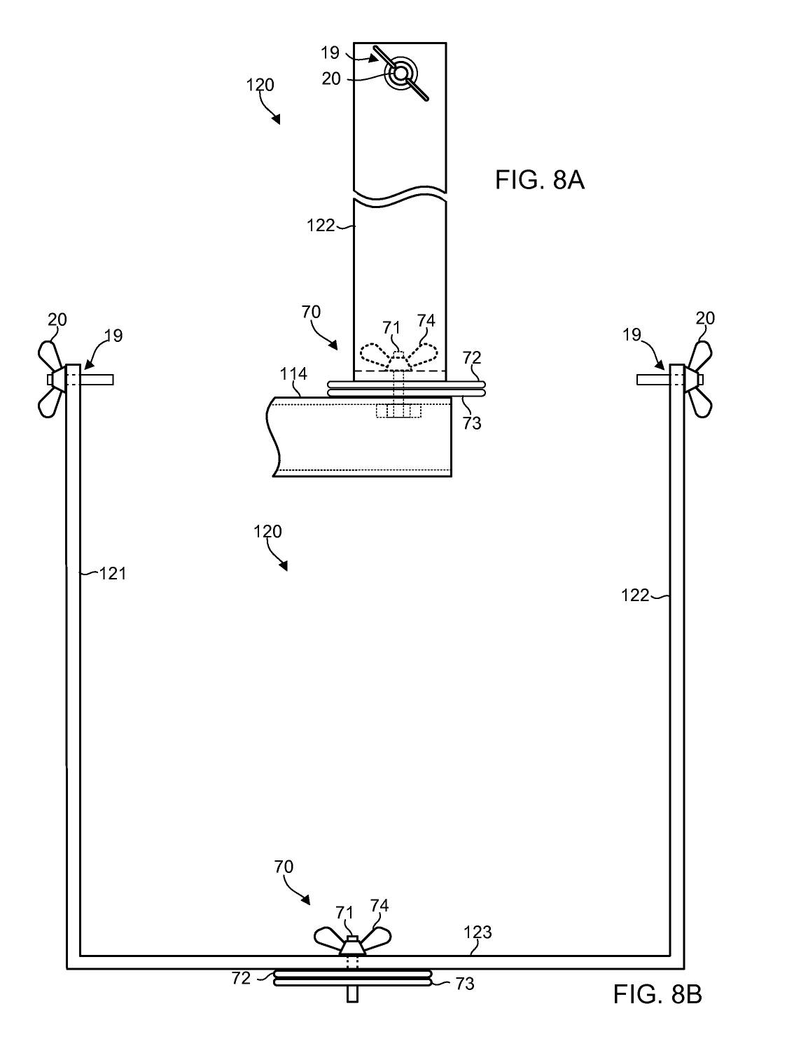

Further details regarding this embodiment are illustrated in FIGS. 8A and 8B. FIG. 8A shows the same basic view as in FIG. 7B, while FIG. 8B shows a front side view. In an embodiment, the fan attachment arms 120 may be in the form of a large U bracket including two side portions 121, 122 each having a pivot attachment assembly 19 for coupling to an electric fan, and a bottom portion 123 coupled to the swivel 70.

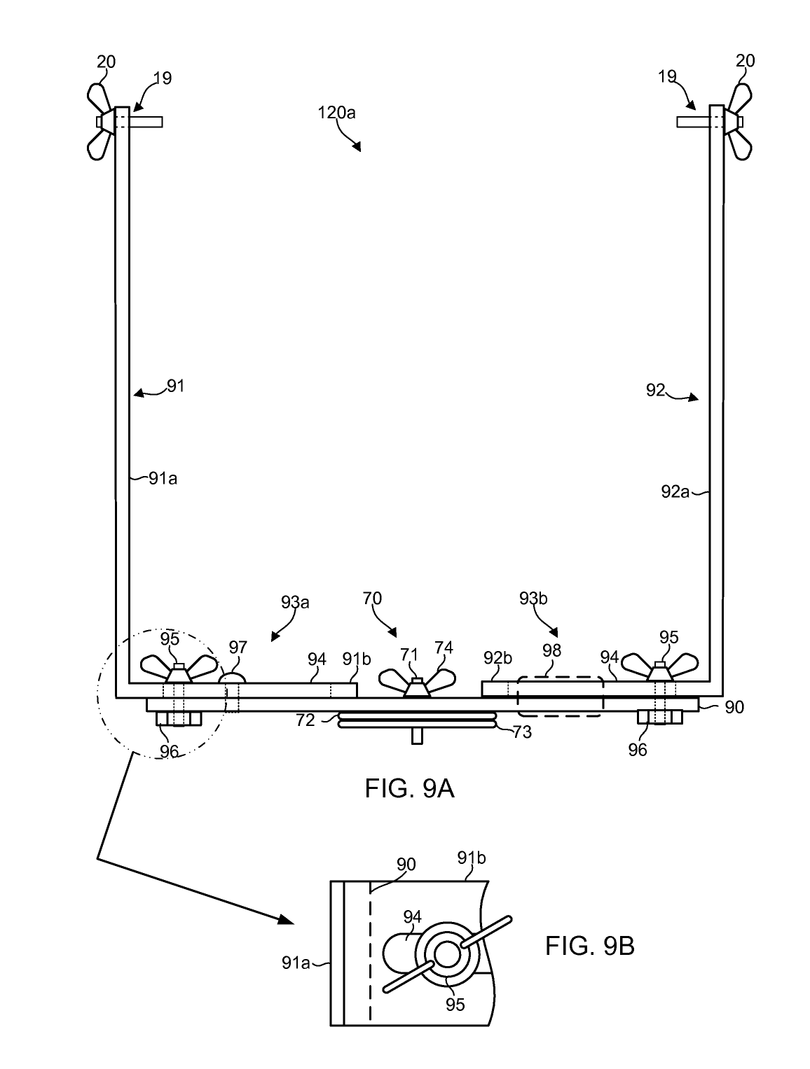

Another embodiment of a fan attachment arm assembly 120a that is capable of expanding or contracting to fit a particular model electric fan is illustrated in FIG. 9A. In this example embodiment, a base member 90 is coupled to the swivel 70 and to first and second fan attachment arm members 91, 92 by sliding coupling assemblies 93a, 93b. In this example embodiment, each fan attachment arm member 91, 92 includes a vertical portion 91a, 92a, and a horizontal member 91b, 92b. A variety of different types of sliding coupling assembly designs may be used.

One type of sliding coupling assembly 93a includes a slot 94 formed in the bottom portion 91b of the fan attachment arm member 91 through which can pass an adjustable tension member, such as a wingnut and bolt assembly 95, 96. To ensure that the fan attachment arm member 91 remains in line with the base member 90, another pin, rivet, or bolt 97 may be coupled to the base member 90 to fit within the slot 94. When the wingnut and bolt assembly 95, 96 is loosened, the fan attachment arm member 91 can be slid towards or away from the swivel 70 in order to accommodate smaller or larger diameter electric fans. The wingnut 95 can then be tightened to hold the assembly in place once the fan attachment arm members 91, 92 are in the proper position to engage the electric fan. FIG. 9B provides a vertical view of the detail portion of the fan attachment arm member 91 showing how the wingnut 95 fits within the slot 94.

Another type of sliding coupling assembly 93b includes a slot 94 formed in the bottom portion 92b through which is positioned a wingnut and bolt assembly 95, 96, and an optional sleeve 98 that wraps around the base member 90 and the bottom portion 92b. The optional sleeve 98 ensures that the fan attachment arm member 91 remains in line with the base member 90. In this type of sliding coupling assembly, the sleeve 98 aligns the fan attachment arm member 92 with the base member 90, while the wingnut and bolt assembly 95, 96 holds the assembly in place once the fan attachment arm members 91, 92 are in the proper position.

In a further type not illustrated, instead of configuring the bottom portion 91b, 92b with a slot 94, a sleeve 98 may be slipped over both the bottom portion and the 91b, 92b and the base member 90, with the sleeve equipped with a tensioning screw (not shown). In this configuration, the sleeve 98 both aligns the fan attachment arm member 91, 92 with the base member 90, and, when the tensioning screw is tightened, holds the assembly in place once the fan attachment arm members 91, 92 are in the proper position.

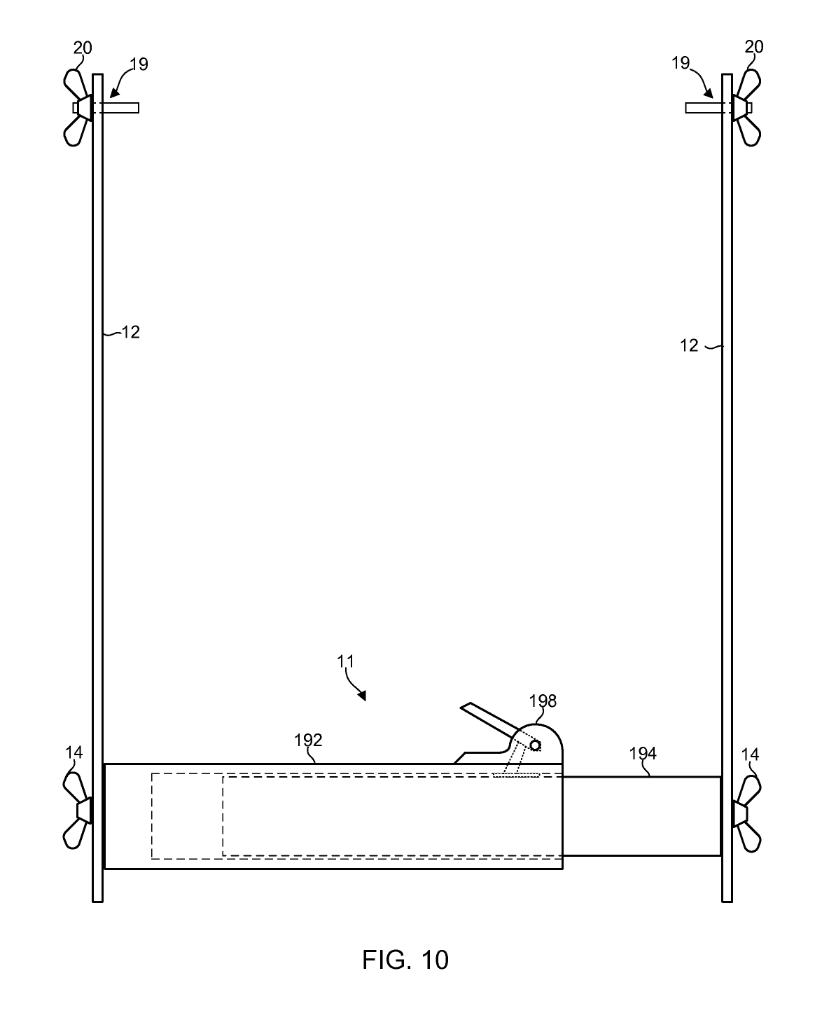

FIG. 10 illustrates a further embodiment that permits the width of the fan support frame 11 to be adjusted to fit a variety of electric fans by expanding or contracting a portion of the frame. Similar to the embodiment described above with reference to FIGS. 5A and 5B, the portions of the fan support frame 11 extending between the fan attachment arms 12 may be configured as two concentric tubes 192, 194 with one tube 194 sized to fit within the other tube 192. A locking mechanism 198 (e.g., used with other types of telescoping tube assemblies) may be provided on the exterior pipe 192 to apply a binding force to the inner tube 194 when in a latched position. A similar configuration may be provided along the portion of the fan support frame 11 that connects to the elevated work platform. When the locking mechanism 198 is in the unlatched position, the two concentric tubes 192, 194 can be pushed together or pulled apart in order to adjust the distance between the two fan attachment arms 12. Once the fan attachment arms 12 are an appropriate distance apart to engage in an electric fan, the locking mechanism 198 may be latched in order to hold the arms in place.

FIG. 11 illustrates another embodiment of the attachment bracket 100 that may be used to couple the fan support frame 11 to a ladder. This bracket 100 may be formed and sized to fit around a leg of a step ladder. One end of the bracket 100 may be adjustably coupled to the fan attachment frame 100 by a bolt 102 with an adjustable nut, such as a wingnut 103. The other end of the bracket may be coupled to an L bracket 101 by a similar bolt 104 and wingnut 105. The bracket 100 can be slipped over the leg of a ladder and then coupled to the fan support frame 11 by threading on the wingnuts 103, 105. Further adjustments of the attachment may be accomplished by providing a slot within the L bracket 101 so that it may be repositioned to accommodate different ladder dimensions, such as by loosening a bolt 106 and wingnut 107 within the slot of the L bracket 101. Once the L bracket is in a proper position to accommodate the leg of the ladder, it may be held in place by tightening the wingnut 107.

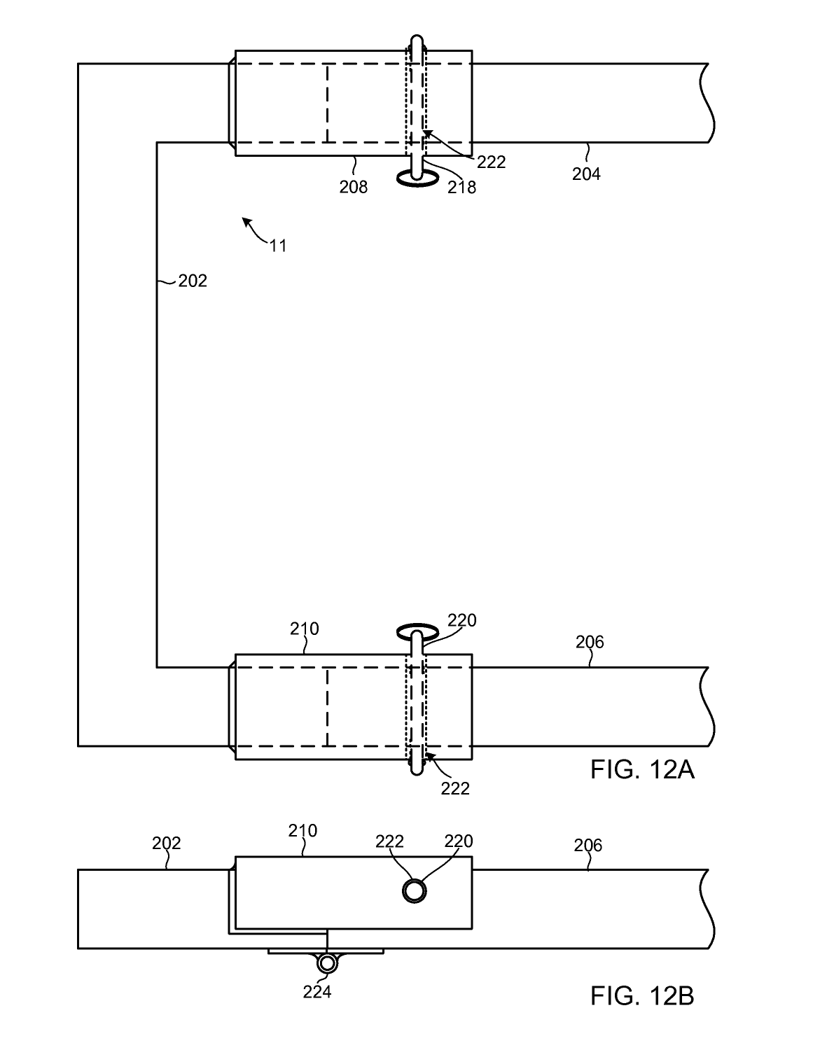

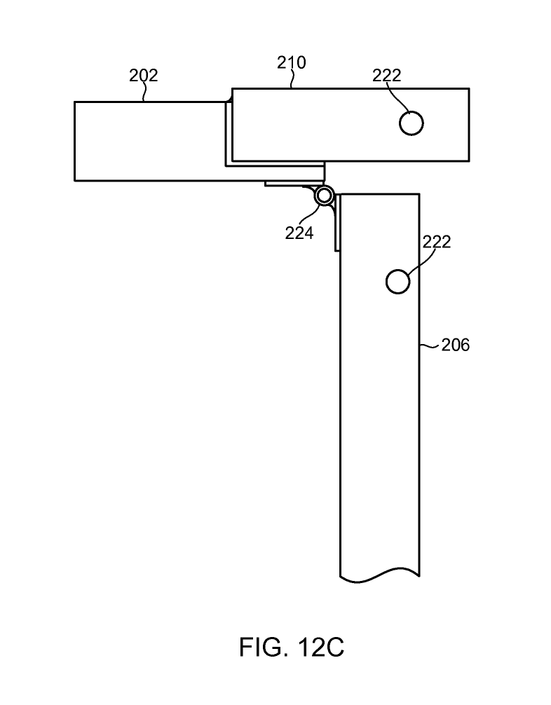

FIGS. 12A through 12B illustrate another embodiment which enables the fan support frame 11 to fold at a hinge allowing the frame to be rotated to a lowered position after the fan support frame 11 has been attached to a ladder or other elevated work platform. Referring to FIG. 12A, the fan support frame 11 may be assembled from a first member 202 and side members 204, 206 which are coupled to the first member 202 by a hinge 224 (see FIG. 12B). In order to maintain the side members 204, 206 in an elevated position parallel to the plane of the first member 202, a coupling sleeve 208, 211 may be attached to the first member 202, such as by bolts (not shown), fasteners (not shown), or welding, and to a side member 204, 206 by a removable locking pin 218, 220. Holes 222 may be drilled through the coupling sleeve 208, 211 and the side member 204, 206 to accommodate the locking pin 218, 220.

Referring to FIG. 12B, a hinge 224 may be positioned beneath and coupled to each of the first member 202 and side member 206. The hinge 224 may be coupled to the first and side members using any known fastening means, such as mechanical fasteners (e.g., bolts, screws, rivets, etc.), welding, adhesives, and so forth. As shown in FIG. 12B, when the locking pin 220 is in position in the through hole 222, the pin will hold the side member 206 in alignment with the first member 202. Thus, in a configuration with the locking pin 220 installed, the side member 206 is held in a first orientation with respect to the first member 202 with an angle of deflection of approximately 0 degrees.

Referring to FIG. 12C, when the locking pin 220 is removed from the coupling sleeve 210, the side member 206 can rotate about the hinge 224. Thus, in a configuration with the locking pin 220 removed, the side member 206 can rotate or pivot about the hinge 224 to a second orientation with respect to the first member 202 with an angle of deflection substantially greater than 0 degrees, such as approximately 90 degrees or more. Such rotation may enable the width of the fan and fan support frame assembly to be reduced, such as in order to fit the assembly through a narrow opening. Using a locking pin 220 in combination with the coupling sleeve 210 enables the fan support frame 11 to be quickly folded down, and then quickly reconfigured into a horizontal orientation simply by lifting the side member 206 back into place and reinserting the locking pin 220.

While the figures show a square fan support frame 11, the frame may be configured in a variety of profiles, including rectangular, circular, elliptical, triangular, and polygonal.

While not illustrated in the figures, the diagonal support braces 15 may also be configured to telescope so their length can be adjusted to fit a variety of different size ladders, scissor lifts and other elevate work structures. This may be accomplished using overlapping structures with slotted couplings as illustrated in FIG. 9A and 9B for the adjustable fan attachment arms 120. Alternatively, a coupling sleeve with an adjustable bolt for applying compression to the sleeve and brace members, similar to the optional sleeve 98 shown in FIG. 9A, may be used for creating an adjustable diagonal support brace.

While the figures show the use of wingnuts as examples of adjustable tension fasteners, other forms of fasteners may be used within the spirit of the invention.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the various embodiments shown herein but is to be accorded the widest scope consistent with the following claims and the principles and novel features disclosed herein.

I claim:

1. A support frame assembly for coupling an electric fan to a ladder, comprising:
a fan support frame;
two fan attachment arms each coupled to the fan support frame by a pivot joint configured to hold each fan attachment arm at an adjustable angle with respect to the fan support frame;
at least one diagonal support brace coupled to the fan support frame by a pivot joint;
a frame attachment bracket coupled to the fan support frame and configured to couple the fan support frame to a structure of the ladder;
an attachment surface coupled to each of the at least one diagonal support brace and configured couple the diagonal support brace to a structure of the ladder; and
a pivot joint assembly coupled to each of the two fan attachment arms and configured to engage an electric fan to hold the fan in an adjustable angle with respect to the two fan attachment arms.

2. The support frame assembly of claim 1, wherein at least a portion of the members of the fan support frame are adjustable in length.

3. The support frame assembly of claim 1, further comprising a swivel coupling the two fan attachment arms to the fan support frame.

4. The support frame assembly of claim 3, wherein a distance between the two fan attachment arms is adjustable.

5. The fan support frame assembly of claim 1, wherein the fan support frame comprises:
first and second members;
a hinge coupled between the first and second members and configured to enable the second member to be rotated with respect to the first member between a first angle of approximately 0 degrees and a second angle substantially greater than 0 degrees;
a coupling sleeve coupled the first member; and
a locking pin configured to pass through a hole in the coupling sleeve and a hole in the second member so as to hold the second member at or near the first angle with respect to the first member.

6. An electric fan assembly configured for mounting on a ladder, comprising:
an electric fan;
two fan attachment arms each coupled to the fan by a pivot joint assembly configured to engage an electric fan to hold the fan in an adjustable angle with respect to the two fan attachment arms;
a fan support frame coupled to the two fan attachment arms by pivot joints configured to hold each fan attachment arm at an adjustable angle with respect to the fan support frame;
at least one diagonal support brace coupled to the fan support frame by a pivot joint;
a frame attachment bracket coupled to the fan support frame and configured to couple the fan support frame to a structure of the ladder; and
an attachment surface coupled to each of the at least one diagonal support brace and configured couple the diagonal support brace to a structure of the ladder.

7. The electric fan assembly of claim 6, wherein the electric fan is battery powered.

8. The electric fan assembly of claim 7, wherein the battery powered electric fan is rechargeable.

9. The electric fan assembly of claim 6, wherein at least a portion of the members of the fan support frame are adjustable in length.

10. The electric fan assembly of claim 6, further comprising a swivel coupling the two fan attachment arms to the fan support frame.

11. The electric fan assembly of claim 10, wherein a distance between the two fan attachment arms is adjustable.

12. The electric fan assembly of claim 6, wherein the fan support frame comprises:
first and second members;
a hinge coupled between the first and second members and configured to enable the second member to be rotated with respect to the first member between a first angle of approximately 0 degrees and a second angle substantially greater than 0 degrees;
a coupling sleeve coupled the first member; and
a locking pin configured to pass through a hole in the coupling sleeve and a hole in the second member so as to hold the second member at or near the first angle with respect to the first member.

13. A ladder and fan assembly, comprising:
a step ladder;
an electric fan;
two fan attachment arms each coupled to the fan by a pivot joint assembly configured to engage an electric fan to hold the fan in an adjustable angle with respect to the two fan attachment arms;
a fan support frame coupled to the two fan attachment arms by pivot joints configured to hold each fan attachment arm at an adjustable angle with respect to the fan support frame;
at least one diagonal support brace coupled to the fan support frame by a pivot joint;
a frame attachment bracket coupled to the fan support frame and coupled to a structure of the ladder; and
an attachment surface coupled to each of the at least one diagonal support brace and to a structure of the ladder.

14. The ladder and fan assembly of claim 13, wherein the electric fan is battery powered.

15. The ladder and fan assembly of claim 14, wherein the battery powered electric fan is rechargeable.

16. The ladder and fan assembly of claim 13, wherein at least a portion of the members of the fan support frame are adjustable in length.

17. The ladder and fan assembly of claim 13, further comprising a swivel coupling the two fan attachment arms to the fan support frame.

18. The ladder and fan assembly of claim 17, wherein a distance between the two fan attachment arms is adjustable.

19. The ladder and fan assembly of claim 13, wherein the fan support frame comprises:
first and second members;
a hinge coupled between the first and second members and configured to enable the second member to be rotated with respect to the first member between a first angle of approximately 0 degrees and a second angle substantially greater than 0 degrees;
a coupling sleeve coupled the first member; and
a locking pin configured to pass through a hole in the coupling sleeve and a hole in the second member so as to hold the second member at or near the first angle with respect to the first member.
